(19) United States
(12) Patent Application Publication
(10) Pub. No.: US 2026/0011050 A1
(43) Pub. Date: Jan. 8, 2026

(54) SYSTEMS AND METHODS FOR GENERATING UNIQUE COLORS FOR OBJECTS BASED ON HASHES OF IDENTIFIER VALUES

(71) Applicant: Meta Platforms, Inc., Menlo Park, CA (US)

(72) Inventor: Shenal Santhush KOTUWEWATTA, Seattle, WA (US)

(73) Assignee: Meta Platforms, Inc., Menlo Park, CA (US)

(21) Appl. No.: 19/255,184

(22) Filed: Jun. 30, 2025

Related U.S. Application Data
(60) Provisional application No. 63/667,937, filed on Jul. 5, 2024.

(51) Int. Cl. G06T 11/00

(52) U.S. Cl. CPC G06T 11/001; G06T 2200/24

(57) ABSTRACT

Systems and methods are disclosed for generating unique colors for objects based on hashes of identifier values. Particularly, the system accomplishes this by generating a hash of an identifier associated with an object and then extracting values from the hash as the values to use for color generation. Given that the hashes of any unique identifiers are unique alphanumeric strings greatly diminishes or eliminates the likelihood that any two colors are the same or are substantially similar. These values from the hash generated for an object identifier may be mapped to color codes that are then used to generate the color to present along with the object via a user interface.

### CROSS-REFERENCE TO RELATED APPLICATION

This application claims priority to and benefit of U.S. provisional patent application No. 63/667,937 filed Jul. 5, 2024, which is hereby incorporated by reference.

### BACKGROUND

For user interfaces, there may be graphical representations (e.g., icons, boxes, etc.) of different objects of the same type (e.g., users, tags, apps, etc.), where it may be beneficial to visually indicate that two objects are different from each other. Generally, this can be done using a profile picture, but for certain objects (such as processes/programs running on a machine), this is impossible or at least impractical. A system can alternatively use the name or identifier of the object, but oftentimes these are long strings of alphanumerical characters that have no meaning to the user and take up lots of visual space. To alleviate this, a system can assign randomly-generated colors to each object. Most existing color generation algorithms use a randomization process to map an initial seed (e.g., an alphanumeric string) to a color.

However, some algorithms are non-deterministic, meaning the same seed can be mapped to different colors at different times. If a user is already familiar with a specific color for representing Object A, they may not recognize Object A if it later appears in a different color. Another example and non-limiting problem is that, oftentimes, the graphical representations are shown next to each other, and different objects can have similar (but not identical) colors that differ by only a few points in the RGB scale. This can make the objects indistinguishable to the human eye. As another example and non-limiting problem, random generators are very prone to generating colors where all three primary color values are low (or all are high), leading to shades of grey that are indistinguishable from each other, and this may look out of place in user interfaces. The system can alleviate the similar color issue by manually picking out a number of colors that are different, but this leads to limited color choices and a need to have separate storage to store and read the list of colors.

### BRIEF DESCRIPTION OF THE DRAWINGS

FIG. 1 illustrates a use case for generating unique colors for objects based on hashes of identifier values in accordance with one or more embodiments of the disclosure.

FIG. 2 illustrates a flow diagram for generating unique colors for objects based on hashes of identifier values in accordance with one or more embodiments of the disclosure.

FIG. 3 illustrates a flow diagram for generating unique RGB colors for objects based on hashes of identifier values in accordance with one or more embodiments of the disclosure.

FIG. 4 illustrates a flow diagram for generating unique HSL colors for objects based on hashes of identifier values in accordance with one or more embodiments of the disclosure.

FIG. 5 illustrates a system for generating unique colors for objects based on hashes of identifier values in accordance with one or more embodiments of the disclosure.

FIG. 6 illustrates schematically illustrates an example architecture of a computer system associated with systems and methods generating unique colors for objects based on hashes of identifier values in accordance with one or more embodiments of the disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

### Overview

Disclosed herein are systems and methods for generating unique colors for objects based on hashes of identifier values. The system addresses the aforementioned technical challenges associated with generating unique colors for objects, and ensures that the values that are generated and ultimately used for color creation differ for each object by a non-negligible amount such that any two colors are visually distinguishable by a human user. Particularly, the system accomplishes this by generating a hash of an identifier associated with an object and then selecting values from the hash as the values to use for color generation. Hashing is generally known in the art to be the process of transforming input data of any size into a fixed-size output, known as a hash, using a hash function. Given that the hashes of the unique identifiers will be unique alphanumeric strings greatly diminishes or eliminates the likelihood that any two colors are the same or are substantially similar. The system accomplishes this in a manner that does not require any color codes generated for an object to be stored in memory, thereby eliminating storage space requirements for the color data.

As an example, there may be two objects that are desired to be presented via a user interface, each with a unique color (however, colors may also be generated for any other number of objects). Each of the two objects may already include a pre-existing identifier. The identifiers may be alphanumeric strings that are unique to the objects, however, the identifiers may also be provided in any other suitable form. In some instances, the identifiers do not necessarily have to be pre-existing and may instead be generated for the objects as a part of the color creation process.

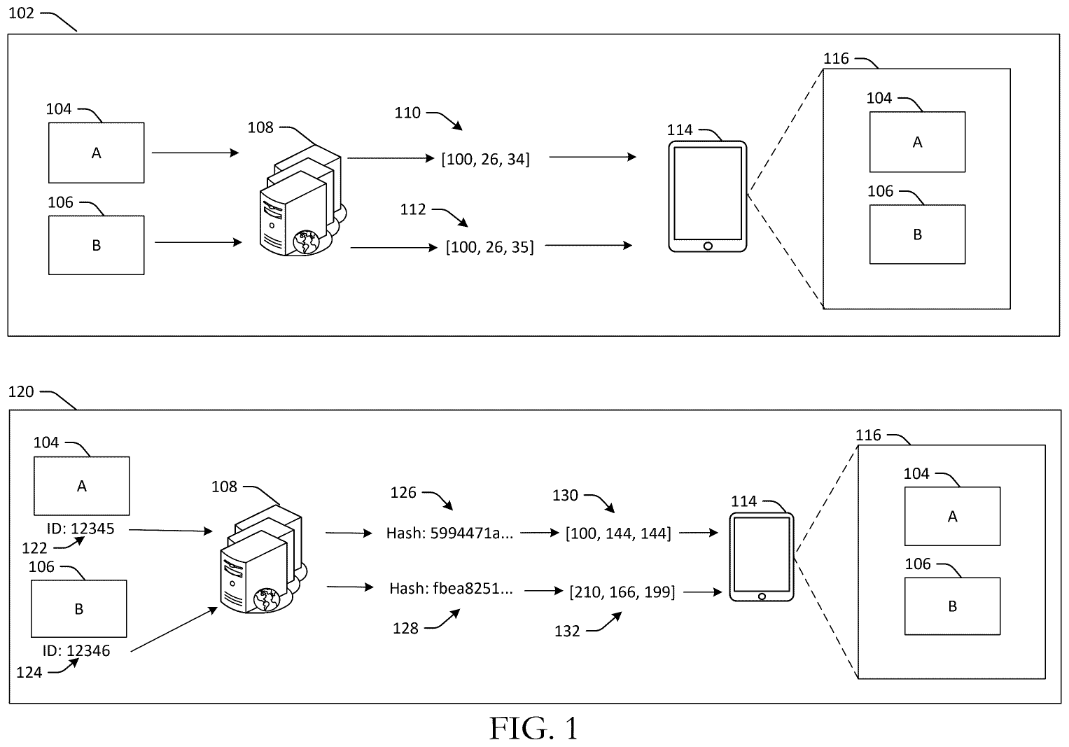

Continuing this example, a hash is generated for each of the identifiers using any suitable hash function, such as hash functions from the Secure Hash Algorithm (SHA) family (SHA-1, SHA-224, SHA-256, SHA-384, SHA-512, SHA-3, etc., the MD Family (MD2, MD4, MD5, MD6, etc.), the RIPEMD Family (RIPEMD-128, RIPEMD-160, RIPEMD-256, RIPE-MD320, etc.), BLAKE2, BLAKE3, JH, Skein, Steebog, Whirlpool, Tiger, Smash, MurmurHash, xxHash, HighwayHash, Pearson Hashing, Zobrist Hashing, or any other known hash function. Specifically, a first hash is generated using a first identifier for the first object and a second hash is generated using a second identifier for the second object (any other number of hashes may be generated depending on the relevant number of objects). More specific examples of identifiers and resulting hashes are shown in FIG. 1.

Once the first hash and the second hash (and/or any other number of hashes) are generated, the values are extracted from the hashes for the color creation. The first hash and the second hash are each made up of a series of alphanumeric characters, and the system determines specific digits of the hashes from which to extract values. In this context, “digit” refers to a position within the hash. For example, the first digit refers to the first position in the hash (the first alphanumeric character). Likewise, the last digit refers to the last position in the hash (the last alphanumeric character). The value at each of the digits refers to the actual alphanumeric character at that position in the hash. For example, in the hash “2eba6544 . . . ,” the value of the first digit would be 2.

In one or more embodiments, the system selects the same digits (that is, the same positions in the first hash and second hash) from which to extract the values for color creation. This is done for consistency and to reduce the likelihood that the same values are selected from the two different hashes. For example, the system may extract a first value from a first digit of the first hash and a second value from the same first digit of the second hash. In other words, the system extracts the values of the first alphanumeric character in each of the hashes. The system may also select any other pairs of values from any other digits of the two hashes. The particular digits that are selected is not necessarily critical as long as the digits are the same for both of the hashes.

The specific approach may vary depending on the type of color scheme that is used for color creation (examples of these color scheme specific approaches are described in further detail below). As an example, if a red, green, blue (RGB) color scheme is used, the system may be configured to obtain values from the hash that are used to determine “R′,” “G′,” and “B“ ” values to create the RGB color. Continuing the example, the system may select a first value from a first digit in the first hash and a second value from the first digit in the first hash for the “R“ ” value, a third value from a second digit in the first hash and a fourth value from the second digit in the first hash for the “G“ ” value, and a fifth value from a third digit in the first hash and a sixth value from the third digit in the first hash for the “R“ ” value.

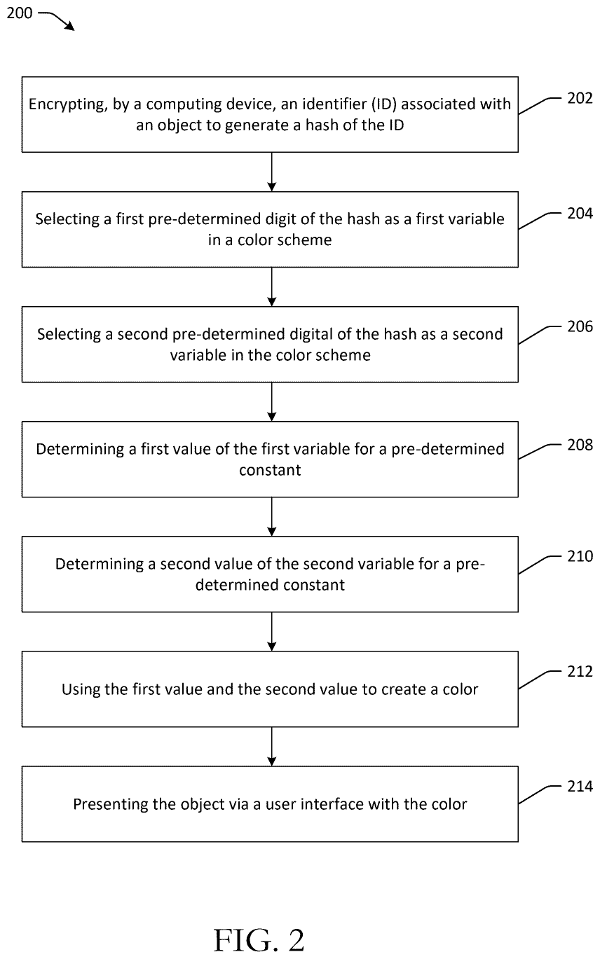

In one or more embodiments, further calculations may be performed using these R′, G′, and B′ values to determine the final R, G, and B values that ultimately are used for color creation. In particular, the system may also map a value of a selected hexadecimal value digit from its original value (e.g., ranging from 0-15) to a number within a range of potential values for the color scheme (for example, 0-255 for the RGB color scheme). This mapping may be performed using a formula, which may vary depending on the type of color scheme (described in further detail below with respect to FIGS. 2-4). The formulas may also be configured to bound the range of potential resulting values to prevent the resulting color from being pure white or pure black, or close to pure white or black. Bounding the potential values in this manner is desired to generate colors that are easily distinguishable from one another and are visible via a user interface. Some interfaces (such as websites, etc.) may include white or black backgrounds and these colors may not be visible against such backgrounds. Additionally, having multiple objects with white and/or black colors would be difficult to distinguish visually. Continuing the example involving the RGB color scheme, the formula may bound the potential values to a range that does not include values of “0” or “255” (given that black in the RGB color space is (0, 0, 0), and white is (255, 255, 255).

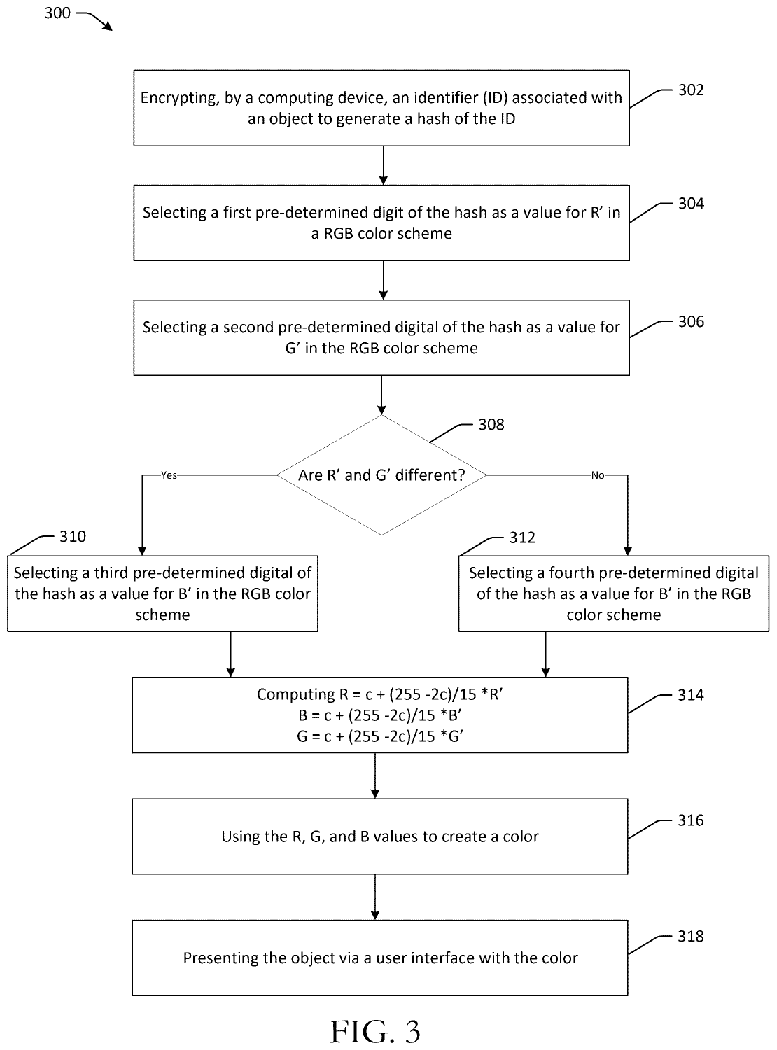

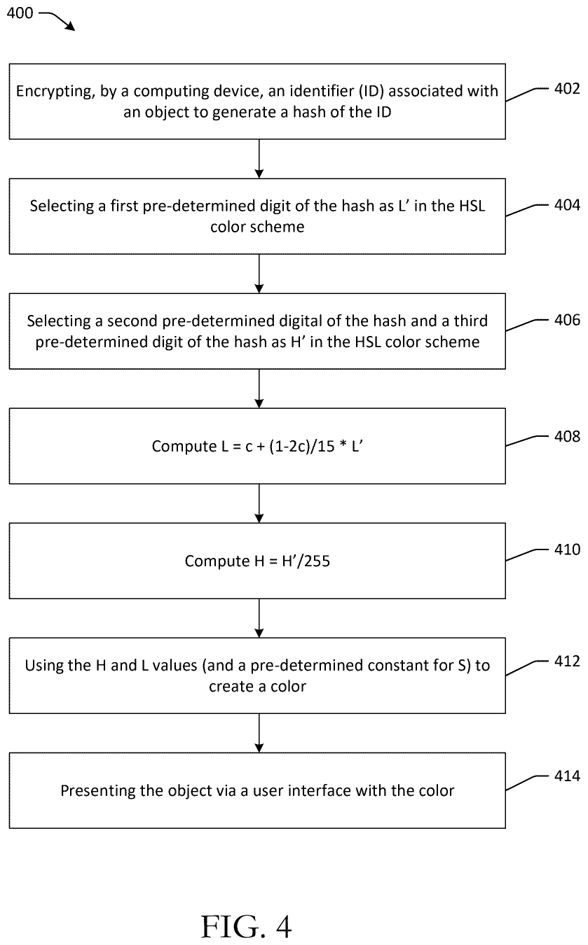

Selection from the first, second, and third digits is merely exemplary and the values may also be selected from any other combination of digits. Further details about the specific process used for creating colors using the RGB color scheme are provided with respect to FIG. 3. FIG. 4 provides details about another process used for creating colors using an HSL color scheme. Although FIGS. 3-4 specifically describe RGB and HSL color schemes, the approach of using hashes of object identifiers to determine values to use for color creation may also be applicable to any other color scheme.

In one or more embodiments, the hashes may specifically be generated in hexadecimal format. Hexadecimal values are known in the art to be numbers represented in base 16, using the digits 0-9 and the letters A-F to represent values 10-15. One benefit of generating a hash in hexadecimal format is that certain color schemes may use hexadecimal values for color coding, such as the RGB color scheme. Accordingly, the values selected for creating the color in such a scheme would already be in the format used for the color creation and would not need to be converted into that format (e.g., converted to a hexadecimal code). For example, the hexadecimal code #FF0000 would represent the RGB code (255, 0, 0), which is a red color (FF is equivalent to 255 and 00 is equivalent to 0). However, the use of the hexadecimal hashes is not necessarily required.

The technology as described herein provides an improved computing system to encrypt an identifier using a hashing function to generate a hash of the identifier. Whereas conventional systems using random number generation have the potential to generate values that are the same or substantially similar (such that a color created using the values would be the same or substantially the same), the system described herein addresses this technical challenge by generating hashes from object identifiers and selecting values of pre-determined digits from the resulting hashes for the color creation. The technology as described herein further improves upon computer systems by improving a user interface of a computer system by allowing for visually distinct colors to be added to objects such that the objects are easily distinguishable by a user viewing the user interface via a computing device.

As such, the present disclosure may provide a deterministic way to generate a color for an object based on just an alphanumeric string (or other ID). This may be beneficial for numerous reasons, including for any interface where there are objects that have to be displayed without a more straightforward graphical representation (such as a profile picture or a logo, or to color nodes for graph representations in a network user interface).

Advantageously, the present disclosure does not require any long-term data storage mechanism (e.g., there is no need to save a list of pre-determined colors as the present disclosure is computational), thereby saving storage space, another technical benefit. That is, given that hashes are used, if the same hashing function is used to generate the hash, and the same identifier is provided to the hashing function, the hashing function would generate the same hash for the object such that the same color can then be created. The present disclosure may be mutually distinguishable, meaning the present disclosure may produce colors that are mutually distinguishable to a person with normal color vision, and the present disclosure may have a large color range (e.g., the present disclosure produces 4096 different colors, which should meet color needs for almost all use cases, given a user will only see a small fraction of this amount at a given time).

### Illustrative Embodiments and Use Cases

FIG. 1 illustrates a use case 100 for generating unique colors for objects based on hashes of identifier values. The use case 100 provides both an example of an approach that uses random number generation (shown in scene 102) to generate the values used for color creation, as well as the approach described herein that uses values in hashes of object identifiers for color creation (shown in scene 120).

Beginning with scene 102, a first object 104 and a second object are shown 106. The two “objects” may be any type of elements that may be visually presented to a user via a user interface. Non-limiting examples may include images, icons, text, combinations of text and icons, and/or any other type of visual element. As indicated above, it may be desired to designate specific colors for different types of objects such that a user can more easily identify the objects on the user interface and distinguish between different types of objects presented via the user interface. In the simplified example shown in FIG. 1, the first object 104 is a box with the character “A” inside and the second object 106 is another box with the character “B” inside.

To determine the specific colors to add to the first object 104 and the second object 106, the computing system 108 performs random number generation to generate the values used for color creation. The range of potential values, number of values, and other parameters may differ based on the color scheme that is used for color creation. In the example shown in FIG. 1, the RGB color scheme is used and the computing system 108 generates random numbers to use for the R, G, and B values. However, as indicated above, one potential technical downside with using a random number generator is that the numbers generated for two different objects may potentially be the same or substantially similar, such that the colors created using the values are indistinguishable on a user interface by a human user. The likelihood of this outcome occurring is increased given that the potential values used in the color schemes include a limited range of values (such as 0-255 for the RGB color scheme). Additionally, in some instances, there may be a large number of objects for which colors are to be generated, which further limits the number of potential color options. In further instances, certain colors may initially be generated and then permanently associated with a particular type of object so that a user can easily identify the object when presented in different user interfaces. In such instances, the number of potential color values would be reduced each time a color is created for a particular object. In the example shown in scene 102, the computing system randomly generates the numbers “100,” “26,” and “34” for the R, G, and B values for the first object 104 and the numbers “100,” “26,” and “35” for the R, G, and B values for the second object 106. This illustrates a scenario where the R values for the first object 104 and the second object 106 are different, however, the values are substantially similar, and the resulting colors generated for the first object 104 and the second object 106 would be virtually indistinguishable by a human user (for example, when presented via the user interface 116 of the computing device 114). In this example, both colors would appear as a dark red via the user interface 116. Although the example shows the computing device 114 as a smartphone, this is not intended to be limiting and any other type of device may be applicable.

Turning to scene 120, the first object 104 and the second object are shown 106 and it is again desired for colors to be created to display with the two objects via the user interface 116 of the computing device 114. However, instead of using a random number generator to generate the values used for the creation of the colors (as is the case in the scene 102), the computing system 108 instead generates a first hash 126 for the first object 104 and a second hash 128 for the second object 106.

The first hash 126 and the second hash 128 may be generated using identifiers for each of the first object 104 and the second object 106. In the example shown in scene 120, the first identifier 122 (“12345”) is associated with the first object 104 and the computing system 108 uses a hashing function to generate a first hash 126 (“5994471a . . . ”) (the actual hash may include a greater number of alphanumerical characters). Likewise, the computing system 108 uses a hashing function to generate a second hash 128 (“fbea8251 . . . ”) for the second object 106 based on the second identifier 124 (“12346”). In some instances, the computing system 108 may us ethe same hash function to generate the first hash 126 and the second hash 128. Again, the actual hash may include a greater number of alphanumerical characters. The specific alphanumeric characters included in the first hash 126 and the second hash 128 may vary depending depend on the hashing function that is employed. In this example, the resulting first hash 126 and second hash 128 are hexadecimal values, however, this is not necessarily required.

Once the first hash 126 and the second hash 128 are generated by the computing system 108, values at pre-determined digits of the first hash 126 and the second hash 128 may be extracted and used to create the colors used for the first object 104 and the second object 106. For purposes of simplicity, the example in scene 120 shows the first digits of the first hash 126 and the second hash 128 (“5” and “f,” respectively) being extracted for use to determine the “R” value, the second digits of the first hash 126 and the second hash 128 (“9” and “b,” respectively) being extracted for use to determine the “G” value, and the third digits of the first hash 126 and the second hash 128 (“9” and “e,” respectively) being extracted to determine the “B” value. However, as indicated elsewhere here, any other digits of the first hash 126 and the second hash 128 may be used instead. As illustrated in scene 120, the resulting RGB values for the first object 104 and the second object 106 have a more substantially difference (5, 9, 9,) versus (15, 11, 14) than the color values produced in the scene 102, even though the identifiers for the first object 104 and the second object 106 only differ by one numerical value.

As illustrated in FIG. 1, the values extracted from the first hash 126 and the second hash 128 are not necessarily the values used to generate the color. Rather, these initial R′, G′, and B′ values extracted from the first hash 126 and the second hash 128 may instead first be mapped to different values and those different values may be used as the values for color creation. For example, rather than using the “5”, “9”,” and “9” values form the first hash 126, these values may be mapped to different values within a larger range of values (such as 0-255 zfor the RGB color space). This is performed to provide a greater color diversity (especially given that hexadecimal values only range from 0-15). In the example shown in FIG. 1, the values extracted from the first hash 126 are mapped to an R value of 100, a G value of 144, and a B value of 144. Likewise, the values extracted from the second hash 128 are mapped to an R value of 210, a G value of 166, and a B value of 199. An RGB color code of (100, 144, 144) maps to a blue-green color, and an RGB color code of (210, 166, 199) maps to a light green color, which are very visually distinct colors, compared to the two dark red colors created in the scene 102.

The mapping may also apply a border to the edges of the potential range of values (e.g., close to “0” and/or “255”). The reason for this is illustrated in the example provided in scene 120. Although (5, 9, 9,) versus (15, 11, 14) appear to be sufficiently different on their face, these RGB color codes actually both represent variations of black and may be indistinguishable by a user via the user interface 116. Therefore, the mapping removes certain values as options to avoid the resulting colors from appearing as black or white.

FIGS. 2-4 illustrate various flow diagrams. Specifically, FIG. 2 illustrates a flow diagram 200 for generating unique colors for objects based on hashes of identifier values. FIG. 3 illustrates a flow diagram 300 for generating unique RGB colors for objects based on hashes of identifier values. FIG. 4 illustrates a flow diagram 400 for generating unique HSL colors for objects based on hashes of identifier values. Any of the processes described as being performed in any of the flow diagrams 200, 300, and 400 may be performed by a computing system (such as, for example, computing system 108, client system 530, social networking system 560, server 562, third-party system 570, computing system 600, and/or any other computing system). In some instances, the processes may be performed across multiple computing systems in a distributed manner.

Beginning with the flow diagram 200, operation 202 involves encrypting an identifier using a hashing algorithm to generate a hash of the ID. Operation 204 involves selecting a first pre-determined digit of the hash as a first variable in a color scheme. Operation 206 involves selecting a second pre-determined digit of the hash as a second variable in the color scheme. Operation 208 involves determining a first value of the first variable for a pre-determined constant. Operation 210 involves determining a second value of the second variable for a pre-determined constant. Operation 212 involves using the first value and the second value to create a color. Operation 214 involves presenting the object via a user interface with the color.

Turning to the flow diagram 300, the RGB color scheme may be used to represent colors in electronic displays, such as computer monitors, televisions, and cameras. It is based on the combination of three primary colors: Red, Green, and Blue. Red (R), Green (G), and Blue (B) are the primary colors used in the RGB color model. Each color is represented by an intensity value, typically on a scale from 0-255. The combination of these colors at varying intensities produces a broad spectrum of colors. By adjusting the intensity of each of the three colors, one can create virtually any color in the visible spectrum. For instance, if all three color values are at their maximum intensity (255, 255, 255), the result is white. If all three color values are at their minimum intensity (0, 0, 0), the result is black. Mixing the colors at different intensities produces various shades, tints, and hues. RGB is an additive color model, meaning that colors are created by combining light of different colors. This is opposite to subtractive color models like Cyan, Magenta, Yellow, and Key (Black) (CMYK) used in printing, where colors are created by subtracting light from a white background through colored inks.

Operation 302 involves encrypting, by a computing system, an identifier (ID) associated with an object to generate a hash of the ID. For instance, the computing system may encrypt an ID (e.g., an alphanumeric ID) using a hashing function (e.g., a hexadecimal hashing function such as MD5, or any other hashing function described herein or otherwise). Any hashing function described herein or otherwise may be used to generate the hash of the identifier.

Operation 304 involves selecting a first pre-determined digit of the hash as a value for R′. R′ is an initial value that is transformed using a formula referenced below to determine the R value used for color creation. Operation 306 involves selecting a second pre-determined digit of the hash as a value for G′. Likewise, G′ is an initial value that is transformed using a formula as described below to determine the G value used for color creation. For example, the computing system may select a first pre-determined digit of the hash as a first variable in a color scheme. Continuing the example, the computing system may select a predefined digit (e.g., the last digit of the hash) as R′. In some implementations, other digits may be selected as well, as long as the specific digits that are selected are consistent throughout the process. For example, if a value of a first digit of the hash is selected to generate a first value to create a color using a color scheme, then the value of the same digit of another hash would also be extracted from that other hash. This reduces the likelihood that different digits with the same values are selected in any two given hashes. In some implementations, the computing system may select at least a second pre-determined digit of the hash as a second variable in the color scheme. For instance, the computing system may select the second-to-last digit of the hash as G′. While operations 302-306 describe determining R′ and G′ values, this is not intended to be limiting and the values for any other combination of R′, G′, and/or B′ values can be extracted in this manner. For example, rather than initially extracting values to use for R′ and G′ from the hash, the values may be used for R′ and B′, G′ and B′, etc.

The reason only two of these values are extracted directly from the hash is to prevent a scenario where the R′, G′, and B′ values are all identical (which may result in identical R, G, and B values), condition 308 may be implemented. Having identical R, G, and B values is undesirable because this would result in a greyscale color. Condition 308 involves determining if R′ and G′ are different values. In this case, R′ and G′ may be replaced by any other combination of two values, depending on the two values that are obtained from the hashes in operations 302-306. If condition 308 is satisfied (that is R′ and G′ are different values), then the flow diagram 300 proceeds to operation 310. If condition 308 is not satisfied (that is R′ and G′ are the same values), then the flow diagram 300 proceeds to operation 312.

Operation 310 involves selecting a third pre-determined digit of the hash as a value for B′ in the RGB color scheme. Operation 312 involves selecting a fourth pre-determined digit of the hash as a value for B′ in the RGB color scheme. For example, if R′ and G′ are different, the computing system may select 104 the third-to-last digit as B′. If R′ and G′ are not different, the computing system may select 104 the last digit different from R′ and G′ as B′. That is, the computing system may identify a digit with a value that is different than the values of the digits selected for R′ and G′ to ensure that at least one of R′, G′, and B′ are different. The specific digits mentioned above are merely exemplary and other digits may also be selected.

Additionally, this specific approach to ensuring that R′, G′, and B′ are not all the same is only one exemplary approach and other approaches may also be used. For example, another approach is to extract all three of R′, G′, and B′ from the hash initially, determine if all three of the values are the same after extraction, and then extract a value of another digit of the hash to replace one of R′, G′, and B′ if this is the case.

Operation 314 involves mapping the R′, G′, and B′ values extracted from the hashes to R, G, and B values that will then be used for color creation. The mapping process maps the colors from a smaller range of values (for example, 0-15 if the hashes are hexadecimal hashes) to the range of potential values for the RGB color scheme (e.g., 0-255). As indicated above, the mapping process may reduce the range to a certain degree (remove some of the potential values at one or more of the edges of the range, such as close to 0 and/or close to 255) to avoid pure black or pure white colors).

In one or more embodiments, the mapping may be performed using a formula, such as R=c+(255−2c)/15*R′. The variable “c” is a pre-defined constant that is used to dictate the size of the spectrum of potential resulting R, G, and B values that can result from the mapping process. A smaller value for “c” results in a larger portion of the color spectrum being usable. In some implementations, a constant value of 45 may be used, although other values may be used. This formula also prevents the mapped R, G, and B values from being too close to “0” or “255,” which prevents the resulting RGB color code from being too close to pure black or pure white, as it is desired for different, distinguishable colors to be provided to the objects rather than black or white. In some implementations, the R, G, and B values may all be within the example range (c, 255-c) for some c, and the difference between any two R, G, and B may be divisible by some positive integer 1, and as an example only, no color has equal R, G, and B values.

Similar formulas may be used to map B′ to B and G′ to G. For example, the formula for mapping B′ to B may be B=c+(255−2c)/15*B′ and the formula for mapping G′ to G may be G=c+(255−2c)/15*G′. This is merely one example of a mapping formula and other variations of the formula may also be used. Additionally, the mapping process does not necessarily need to involve the use of a formula and other mapping techniques can also be used (e.g., look-up table, etc.).

Operation 316 involves using the R, G, and B values to create a color. Operation 318 involves presenting the object via a user interface with the color.

Turning to the flow diagram 400, the HSL color scheme is a way to represent colors based on three components: Hue, Saturation, and Lightness. Hue (“H”) is the color type, which is represented as a degree on the color wheel from 0 to 360. For example, 0 or 360 degrees is red, 120 degrees is green, and 240 degrees is blue. Saturation (“S”) represents the intensity of the hue. Saturation ranges from 0% (which is a shade of gray) to 100%, where the color is fully saturated, meaning it appears the most vivid. Lightness (“L”) measures the brightness of the color. A lightness of 0% is black, 50% is the color as it appears in pure, direct light, and 100% is white. The HSL color model allows adjusting of the coloring aspects that are more intuitive and visually oriented tint, shade, and tone-by manipulating saturation and lightness, while maintaining the same hue. This model may also be beneficial in digital media and graphic design software to achieve a more fine-tuned color selection.

The flow diagram 400 includes some similar operations as flow diagram 300. That is, in some instances, some operations may be performed regardless of the color scheme that is used. For example, operations 402-406 involve generating for object identifiers and extracting values from pre-determined digits of the resulting hashes.

Specifically, operation 402 involves encrypting, by a computing device, an identifier (ID) associated with an object to generate a hash of the identifier using a hashing function (e.g., a hexadecimal hashing function such as MD5, or any other hashing function described herein or otherwise). Operation 404 involves selecting a first pre-determined digit of the hash as L′ in the HSL color scheme. For instance, the computing system may the last digit of the hash as L′. In some implementations, other digits may be selected as well, as long as they are consistent throughout the process. Operation 406 involves selecting a second pre-determined digit of the hash and a third pre-determined digit of the hash as H′ in the HSL color scheme. For instance, the computing system may the second-to-last and third-to-last digit of the hash as a hexadecimal number H′ (which then falls in the example range of 0-255). It will be appreciated after reading the present disclosure that non-hexadecimal numbers may be used, which may then be converted back into a hexadecimal number (if needed). Additionally, as mentioned elsewhere herein, the specific digits mentioned in these operations are merely exemplary and other digits of the hashes may also be used.

Operations 408 and 410 involve computing values for L and H. In some implementations, the computing system may determine 106 a first value of the first variable for a pre-determined constant. In one or more embodiments, the computing system may determine L using the following formula for some pre-determined constant c: L=c+(1−2c)/15*L′. As examples, c may be set to 0.2 and S may be set to 0.6, however, other values may be used. In one or more embodiments, the computing system may determine using the formula H=H′/255, where H is 255 in this example. As mentioned in the description of FIG. 3 for the RGB color space, this is merely one example of a mapping formula and other variations of the formula may also be used. Additionally, the mapping process does not necessarily need to involve the use of a formula and other mapping techniques can also be used (e.g., look-up table, etc.).

Operation 412 involves using the H and L values (and a pre-determined constant for S) to create a color. For instance, the computing system may create the HSL color for the object using the computed H and L values and a pre-determined constant for S. In some implementations, the saturation value may be identical (or within a small pre-determined range) for all colors, and the hue values may be all within the example range (c, 1-c) for some c. In some implementations, use of the HSL color scheme may produce less monotone palettes compared to the RGB color scheme. It will be appreciated that the constants may be adjusted according to the product as a tradeoff between higher contrast and more colors. Operation 414 involves presenting the object via a user interface with the color.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure. The above-described embodiments and additional and/or alternative embodiments of the disclosure will be described in detail hereinafter through reference to the accompanying drawings.

One or more operations of the methods, process flows, or use cases of FIGS. 1-4 may have been described above as being performed by a computing system, or more specifically, by one or more program module(s), applications, or the like executing on a device. It should be appreciated, however, that any of the operations of the methods, process flows, or use cases of FIGS. 1-4 may be performed, at least in part, in a distributed manner by one or more other devices, or more specifically, by one or more program module(s), applications, or the like executing on such devices. In addition, it should be appreciated that processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-4 may be described in the context of the illustrative devices, it should be appreciated that such operations may be implemented in connection with numerous other device configurations.

The operations described and depicted in the illustrative methods, process flows, and use cases of FIGS. 1-4 may be carried out or performed in any suitable order, such as the depicted orders, as desired in various example embodiments of the disclosure. Additionally, in certain example embodiments, at least a portion of the operations may be carried out in parallel. Furthermore, in certain example embodiments, less, more, or different operations than those depicted in FIGS. 1-4 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by the execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

### Illustrative Computer Architecture

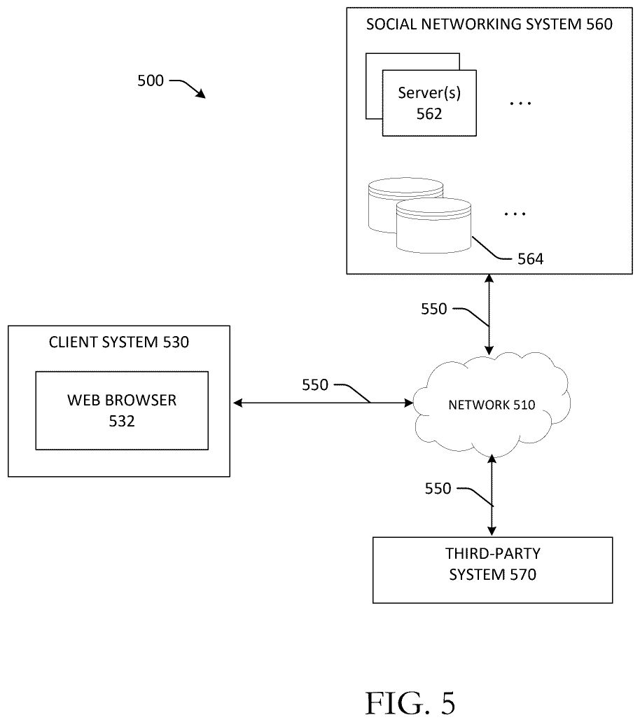

FIG. 5 illustrates an example network environment 500 associated with a social-networking system. Network environment 500 may implement one or more aspects of the flow diagrams 200-400 already discussed.

Network environment 500 includes a client system 530, a social-networking system 560, and a third-party system 570 connected to each other by a network 510. Although the figures illustrates a particular arrangement of client system 530, social-networking system 560, third-party system 570, and network 510, this disclosure contemplates any suitable arrangement of client system 530, social-networking system 560, third-party system 570, and network 510. As an example and not by way of limitation, two or more of client system 530, social-networking system 560, and third-party system 570 may be connected to each other directly, bypassing network 510. As another example, two or more of client system 530, social-networking system 560, and third-party system 570 may be physically or logically co-located with each other in whole or in part. Moreover, although FIG. 5 illustrates a particular number of client systems 530, social-networking systems 560, third-party systems 570, and networks 510, this disclosure contemplates any suitable number of client systems 530, social-networking systems 560, third-party systems 570, and networks 510. As an example and not by way of limitation, network environment 500 may include multiple client system 530, social-networking systems 560, third-party systems 570, and networks 510. Furthermore, although reference is made specifically to a social networking system 560, the color creation technique described herein may be applicable to any other type of system as well (that is, the colors may be created for any other type of use cases).

This disclosure contemplates any suitable network 510. As an example and not by way of limitation, one or more portions of network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these.

Network 510 may include one or more networks 510. Links 550 may connect client system 530, social-networking system 560, and third-party system 570 to communication network 510 or to each other. This disclosure contemplates any suitable links 550. In particular examples, one or more links 550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout network environment 500. One or more first links 550 may differ in one or more respects from one or more second links 550.

In particular examples, client system 530 may be an electronic device including hardware, software, or embedded logic components or a combination of two or more such components and capable of carrying out the appropriate functionalities implemented or supported by client system 530. As an example and not by way of limitation, a client system 530 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 530. A client system 530 may enable a network user at client system 530 to access network 510. A client system 530 may enable its user to communicate with other users at other client systems 530.

In particular examples, client system 530 may include a web browser 532, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 530 may enter a Uniform Resource Locator (URL) or other address directing the web browser 532 to a particular server (such as server 562, or a server associated with a third-party system 570), and the web browser 532 may generate a Hyper Text Transfer Protocol (HTTP) request and communicate the HTTP request to server. The server may accept the HTTP request and communicate to client system 530 one or more Hyper Text Markup Language (HTML) files responsive to the HTTP request. Client system 530 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular desires. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular examples, social-networking system 560 may be a network-addressable computing system that can host an online social network. Social-networking system 560 may generate, store, receive, and send social-networking data, such as, for example, user-profile data, concept-profile data, social-graph information, or other suitable data related to the online social network. Social-networking system 560 may be accessed by the other components of network environment 500 either directly or via network 510. As an example and not by way of limitation, client system 530 may access social-networking system 560 using a web browser 532, or a native application associated with social-networking system 560 (e.g., a mobile social-networking application, a messaging application, another suitable application, or any combination thereof) either directly or via network 510. In particular examples, social-networking system 560 may include one or more servers 562.

Each server 562 may be a unitary server or a distributed server spanning multiple computers or multiple datacenters. Servers 562 may be of various types, such as, for example and without limitation, web server, news server, mail server, message server, advertising server, file server, application server, exchange server, database server, proxy server, another server suitable for performing functions or processes described herein, or any combination thereof. In particular examples, each server 562 may include hardware, software, or embedded logic components or a combination of two or more such components for carrying out the appropriate functionalities implemented or supported by server 562. In particular examples, social-networking system 560 may include one or more data stores 564. Data stores 564 may be used to store various types of information. In particular examples, the information stored in data stores 564 may be organized according to specific data structures. In particular examples, each data store 564 may be a relational, columnar, correlation, or other suitable database.

Although this disclosure describes or illustrates particular types of databases, this disclosure contemplates any suitable types of databases. Particular examples may provide interfaces that enable a client system 530, a social-networking system 560, or a third-party system 570 to manage, retrieve, modify, add, or delete, the information stored in data store 564.

In particular examples, social-networking system 560 may store one or more social graphs in one or more data stores 564. In particular examples, a social graph may include multiple nodes-which may include multiple user nodes (each corresponding to a particular user) or multiple concept nodes (each corresponding to a particular concept)—and multiple edges connecting the nodes. Social-networking system 560 may provide users of the online social network the ability to communicate and interact with other users. In particular examples, users may join the online social network via social-networking system 560 and then add connections (e.g., relationships) to a number of other users of social-networking system 560 to whom they want to be connected. Herein, the term “friend” may refer to any other user of social-networking system 560 with whom a user has formed a connection, association, or relationship via social-networking system 560.

In particular examples, social-networking system 560 may provide users with the ability to take actions on various types of items or objects, supported by social-networking system 560. As an example and not by way of limitation, the items and objects may include groups or social networks to which users of social-networking system 560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 560 or by an external system of third-party system 570, which is separate from social-networking system 560 and coupled to social-networking system 560 via a network 510.

In particular examples, social-networking system 560 may be capable of linking a variety of entities. As an example and not by way of limitation, social-networking system 560 may enable users to interact with each other as well as receive content from third-party systems 570 or other entities, or to allow users to interact with these entities through an application programming interfaces (API) or other communication channels.

In particular examples, a third-party system 570 may include one or more types of servers, one or more data stores, one or more interfaces, including but not limited to APIs, one or more web services, one or more content sources, one or more networks, or any other suitable components, e.g., that servers may communicate with. A third-party system 570 may be operated by a different entity from an entity operating social-networking system 560. In particular examples, however, social-networking system 560 and third-party systems 570 may operate in conjunction with each other to provide social-networking services to users of

social-networking system 560 or third-party systems 570. In this sense, social-networking system 560 may provide a platform, or backbone, which other systems, such as third-party systems 570, may use to provide social-networking services and functionality to users across the Internet.

In particular examples, a third-party system 570 may include a third-party content object provider. A third-party content object provider may include one or more sources of content objects, which may be communicated to a client system 530. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular examples, social-networking system 560 also includes user-generated content objects, which may enhance a user's interactions with social-networking system 560. User-generated content may include anything a user can add, upload, send, or “post” to social-networking system 560. As an example and not by way of limitation, a user communicates posts to social-networking system 560 from a client system 530. Posts may include data such as status updates or other textual data, location information, photos, videos, links, music or other similar data or media. Content may also be added to social-networking system 560 by a third-party through a “communication channel,” such as a newsfeed or stream.

In particular examples, social-networking system 560 may include a variety of servers, sub-systems, programs, modules, logs, and data stores. In particular examples, social-networking system 560 may include or a combination of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 560 may also include suitable components such as network interfaces, security mechanisms, load balancers, failover servers, management-and-network-operations consoles, other suitable components, or any suitable combination thereof. In particular examples, social-networking system 560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 560 to one or more client systems 530 or one or more third-party system 570 via network 510. The web server may include a mail server or other messaging functionality for receiving and routing messages between social-networking system 560 and one or more client systems 530. An API-request server may allow a third-party system 570 to access information from social-networking system 560 by calling one or more APIs. An action logger may be used to receive communications from a web server about a user's actions on or off social-networking system 560. In conjunction with the action log, a third-party-content-object log may be maintained of user exposures to third-party-content objects. A notification controller may provide information regarding content objects to a client system 530. Information may be pushed to a client system 530 as notifications, or information may be pulled from client system 530 responsive to a request received from client system 530. Authorization servers may be used to enforce one or more privacy settings of the users of social-networking system 560. A privacy setting of a user determines how particular information associated with a user can be shared. The authorization server may allow users to opt in to or opt out of having their actions logged by social-networking system 560 or shared with other systems (e.g., third-party system 570), such as, for example, by setting appropriate privacy settings. Third-party-content-object stores may be used to store content objects received from third parties, such as a third-party system 570. Location stores may be used for storing location information received from client systems 530 associated with users. Advertisement-pricing modules may combine social information, the current time, location information, or other suitable information to provide relevant advertisements, in the form of notifications, to a user.

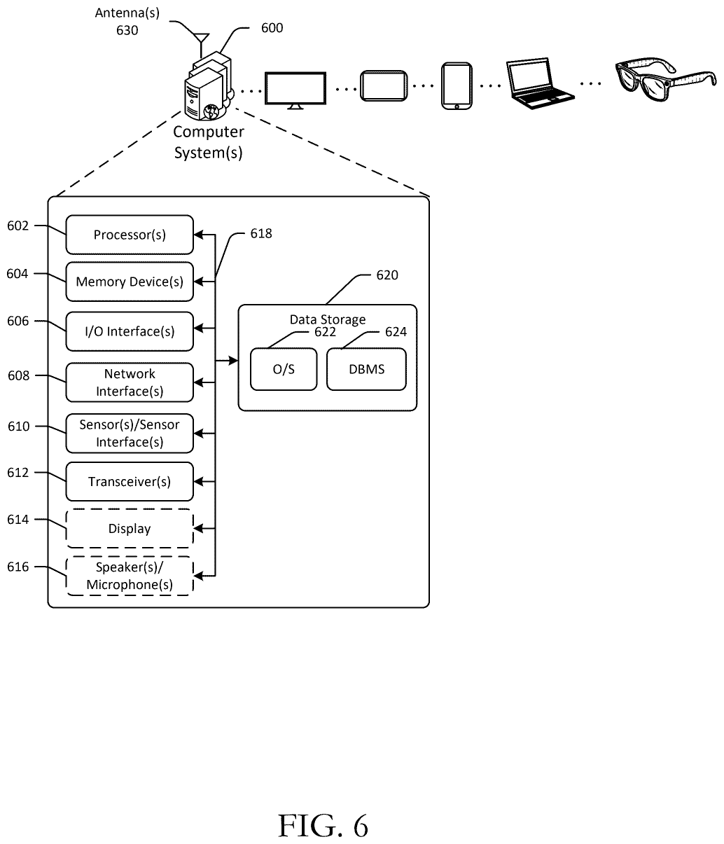

FIG. 6 is a schematic block diagram of one or more illustrative computing system(s) 600 in accordance with one or more example embodiments of the disclosure. The computing system(s) 600 may include any suitable computing device including, but not limited to, a server system, a voice interaction device, a mobile device such as a smartphone, a tablet, an e-reader, a wearable device, or the like; a desktop computer; a laptop computer; a content streaming device; or the like. The computing system(s) 600 may correspond to an illustrative device configuration for the device(s) of FIGS. 1-4 (such as computing system 108, client system 530, social networking system 560, server 562, third-party system 570, and system described as performing any processes associated with the flow diagrams of FIGS. 2-4, etc.).

The computing system(s) 600 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing system(s) 600 may include one or more processors (processor(s)) 602, one or more memory devices 604 (also referred to herein as memory 604), one or more input/output (I/O) interface(s) 606, one or more network interface(s) 608, one or more sensor(s) or sensor interface(s) 610, one or more transceiver(s) 612, one or more optional display(s) 614, one or more optional microphone(s) 616, and data storage 620. The computing system(s) 600 may further include one or more bus(es) 618 that functionally couple various components of the computing system(s) 600. The computing system(s) 600 may further include one or more antenna(s) 630 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 618 may include at least one of a system bus, a memory bus, an address bus, or a message bus, and may permit the exchange of information (e.g., data (including computer-executable code), signaling, etc.) between various components of the computing system(s) 600. The bus(es) 618 may include, without limitation, a memory bus or a memory controller, a peripheral bus, an accelerated graphics port, and so forth. The bus(es) 618 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 604 of the computing system(s) 600 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 604 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 604 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 620 may include removable storage and/or non-removable storage including, but not limited to, magnetic storage, optical disk storage, and/or tape storage. The data storage 620 may provide non-volatile storage of computer-executable instructions and other data. The memory 604 and the data storage 620, removable and/or non-removable, are examples of computer-readable storage media (CRSM) as that term is used herein.

The data storage 620 may store computer-executable code, instructions, or the like that may be loadable into the memory 604 and executable by the processor(s) 602 to cause the processor(s) 602 to perform or initiate various operations. The data storage 620 may additionally store data that may be copied to the memory 604 for use by the processor(s) 602 during the execution of the computer-executable instructions. Moreover, output data generated as a result of execution of the computer-executable instructions by the processor(s) 602 may be stored initially in the memory 604, and may ultimately be copied to the data storage 620 for non-volatile storage.

More specifically, the data storage 620 may store one or more operating systems (O/S) 622; one or more database management systems (DBMS) 624; and one or more program module(s), applications, engines, computer-executable code, scripts, or the like. Some or all of these module(s) may be sub-module(s). Any of the components depicted as being stored in the data storage 620 may include any combination of software, firmware, and/or hardware. The software and/or firmware may include computer-executable code, instructions, or the like that may be loaded into the memory 604 for execution by one or more of the processor(s) 602. Any of the components depicted as being stored in the data storage 620 may support functionality described in reference to corresponding components named earlier in this disclosure.

The data storage 620 may further store various types of data utilized by the components of the computing system(s) 600. Any data stored in the data storage 620 may be loaded into the memory 604 for use by the processor(s) 602 in executing computer-executable code. In addition, any data depicted as being stored in the data storage 620 may potentially be stored in one or more datastore(s) and may be accessed via the DBMS 624 and loaded in the memory 604 for use by the processor(s) 602 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like.

The processor(s) 602 may be configured to access the memory 604 and execute the computer-executable instructions loaded therein. For example, the processor(s) 602 may be configured to execute the computer-executable instructions of the various program module(s), applications, engines, or the like of the computing system(s) 600 to cause or facilitate various operations to be performed in accordance with one or more embodiments of the disclosure. The processor(s) 602 may include any suitable processing unit capable of accepting data as input, processing the input data in accordance with stored computer-executable instructions, and generating output data. The processor(s) 602 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 602 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 602 may be capable of supporting any of a variety of instruction sets.

Referring now to other illustrative components depicted as being stored in the data storage 620, the O/S 622 may be loaded from the data storage 620 into the memory 604 and may provide an interface between other application software executing on the computing system(s) 600 and the hardware resources of the computing system(s) 600. More specifically, the O/S 622 may include a set of computer-executable instructions for managing the hardware resources of the computing system(s) 600 and for providing common services to other application programs (e.g., managing memory allocation among various application programs). In certain example embodiments, the O/S 622 may control execution of the other program module(s). The O/S 622 may include any operating system now known or which may be developed in the future including, but not limited to, any server operating system, any mainframe operating system, or any other proprictary or non-proprietary operating system.

The DBMS 624 may be loaded into the memory 604 and may support functionality for accessing, retrieving, storing, and/or manipulating data stored in the memory 604 and/or data stored in the data storage 620. The DBMS 624 may use any of a variety of database models (e.g., relational model, object model, etc.) and may support any of a variety of query languages. The DBMS 624 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computing system(s) 600 is a mobile device, the DBMS 624 may be any suitable lightweight DBMS optimized for performance on a mobile device.

Referring now to other illustrative components of the computing system(s) 600, the input/output (I/O) interface(s) 606 may facilitate the receipt of input information by the computing system(s) 600 from one or more I/O devices as well as the output of information from the computing system(s) 600 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing system(s) 600 or may be separate. The I/O devices may further include, for example, any number of peripheral devices such as data storage devices, printing devices, and so forth.

The I/O interface(s) 606 may also include an interface for an external peripheral device connection such as universal serial bus (USB), Fire Wire, Thunderbolt, Ethernet port or other connection protocol that may connect to one or more networks. The I/O interface(s) 606 may also include a connection to one or more of the antenna(s) 630 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, a ZigBee network, etc.

The computing system(s) 600 may further include one or more network interface(s) 608 via which the computing system(s) 600 may communicate with any of a variety of other systems, platforms, networks, devices, and so forth. The network interface(s) 608 may enable communication, for example, with one or more wireless routers, one or more host servers, one or more web servers, and the like via one or more networks.

The antenna(s) 630 may include any suitable type of antenna depending, for example, on the communications protocols used to transmit or receive signals via the antenna(s) 630. Non-limiting examples of suitable antennas may include directional antennas, non-directional antennas, dipole antennas, folded dipole antennas, patch antennas, multiple-input multiple-output (MIMO) antennas, or the like. The antenna(s) 630 may be communicatively coupled to one or more transceivers 612 or radio components to which or from which signals may be transmitted or received.

As previously described, the antenna(s) 630 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(s) 630 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11 g, 802.11n), 5 GHz channels (e.g., 802.11n, 802.11ac), or 60 GHz channels (e.g., 802.1 lad). In alternative example embodiments, the antenna(s) 630 may be configured to transmit or receive radio frequency signals within any suitable frequency range forming part of the unlicensed portion of the radio spectrum.

The antenna(s) 630 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 612 may include any suitable radio component(s) for—in cooperation with the antenna(s) 630—transmitting or receiving radio frequency (RF) signals in the bandwidth and/or channels corresponding to the communications protocols utilized by the computing system(s) 600 to communicate with other devices. The transceiver(s) 612 may include hardware, software, and/or firmware for modulating, transmitting, or receiving-potentially in cooperation with any of antenna(s) 630—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 612 may further include hardware, firmware, or software for receiving GNSS signals. The transceiver(s) 612 may include any known receiver and baseband suitable for communicating via the communications protocols utilized by the computing system(s) 600. The transceiver(s) 612 may further include a low noise amplifier (LNA), additional signal amplifiers, an analog-to-digital (A/D) converter, one or more buffers, a digital baseband, or the like.

The sensor(s)/sensor interface(s) 610 may include or may be capable of interfacing with any suitable type of sensing device such as, for example, inertial sensors, force sensors, thermal sensors, photocells, and so forth. Example types of inertial sensors may include accelerometers (e.g., MEMS-based accelerometers), gyroscopes, and so forth.

The optional display(s) 614 may be configured to output light and/or render content. The optional speaker(s)/microphone(s) 616 may be any device configured to receive analog sound input or voice data.

It should be appreciated that the program module(s), applications, computer-executable instructions, code, or the like depicted in FIG. 6 as being stored in the data storage 620 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the computing system(s) 600, and/or hosted on other computing device(s) accessible via one or more networks, may be provided to support functionality provided by the program module(s), applications, or computer-executable code depicted in FIG. 6 and/or additional or alternate functionality. Further, functionality may be modularized differently such that processing described as being supported collectively by the collection of program module(s) depicted in FIG. 6 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 6 may be implemented, at least partially, in hardware and/or firmware across any number of devices.

It should further be appreciated that the computing system(s) 600 may include alternate and/or additional hardware, software, or firmware components beyond those described or depicted without departing from the scope of the disclosure. More particularly, it should be appreciated that software, firmware, or hardware components depicted as forming part of the computing system(s) 600 are merely illustrative and that some components may not be present or additional components may be provided in various embodiments. While various illustrative program module(s) have been depicted and described as software module(s) stored in the data storage 620, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for case of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A computer-implemented method comprising:
encrypting, by one or more processors, a first identifier associated with a first object to generate a first hash of the first identifier;
selecting, by the one or more processors, a first pre-determined digit of the first hash as a first variable in a color scheme;
selecting, by the one or more processors, a second pre-determined digit of the first hash as a second variable in the color scheme;
determining, by the one or more processors, a first value of the first hash at the first pre-determined digit;
determining, by the one or more processors, a second value of the first hash at the second pre-determined digit;
generating, by the one or more processors, a first color using the first value and the second value; and
presenting, by the one or more processors, a user interface including the first object and the first color associated with the first object.

2. The computer-implemented method of claim 1, further comprising:
encrypting, by one or more processors, a second identifier associated with a second object to generate a second hash of the second identifier;
determining, by the one or more processors, a third value of the second hash at the first pre-determined digit;
determining, by the one or more processors, a fourth value of the second hash at the second pre-determined digit;
generating, by the one or more processors, a second color using the third value and the fourth value, wherein the second color is different than the first color; and
presenting, by the one or more processors, a user interface including the second object and the second color associated with the second object.

3. The computer-implemented method of claim 1, wherein the first value and the second value are used as values for at least one of a red value, a green value, or a blue value of a red, green, and blue (RGB) color scheme.

4. The computer-implemented method of claim 3, further comprising:
determining, by the one or more processors, that the first value is different than the second value; and
determining, by the one or more processors and based on the determination that the first value is different than the second value, a third value of the first hash at a third pre-determined digit.

5. The computer-implemented method of claim 3, further comprising:
determining, by the one or more processors, that the first value is different than the second value; and
identifying, by the one or more processors and based on the determination that the first value is equivalent to the second value, a third value of the first hash that is different than the first value and the second value.

6. The computer-implemented method of claim 1, wherein the wherein the first value and the second value are used as values for at least one of a hue value, a saturation value, or a lightness value of a hue, saturation, and lightness (HSL) color scheme.

7. The computer-implemented method of claim 1, wherein generating the first hash is performed instead of using random number generation.

8. The computer-implemented method of claim 1, wherein the first hash of the first identifier is a hexadecimal hash.

9. A system comprising:
at least one processor; and
at least one memory storing computer-executable instructions, that when executed by the at least one processor, cause the at least one processor to:
encrypt an first identifier associated with a first object to generate a first hash of the first identifier;
select a first pre-determined digit of the first hash as a first variable in a color scheme;
select at least a second pre-determined digit of the first hash as a second variable in the color scheme;
determine a first value of the first hash at the first pre-determined digit;
determine a second value of the first hash at the second pre-determined digit;
generate a first color using the first value and the second value; and
presenting, by the one or more processors, a user interface including the first object and the first color associated with the first object.

10. The system of claim 9, wherein the computer-executable instructions, when executed by the at least one processor, further cause the at least one processor to:
encrypt a second identifier associated with a second object to generate a second hash of the second identifier;
determine, a third value of the second hash at the first pre-determined digit;
determine a fourth value of the second hash at the second pre-determined digit; and
generate a second color using the third value and the fourth value, wherein the second color is different than the first color; and
present a user interface including the second object and the second color associated with the second object.

11. The system of claim 9, wherein the first value and the second value are used as values for at least one of a red value, a green value, or a blue value of a red, green, and blue (RGB) color scheme.

12. The system of claim 11, wherein the computer-executable instructions, when executed by the at least one processor, further cause the at least one processor to:
determine that the first value is different than the second value; and
determine, based on the determination that the first value is different than the second value, a third value of the first hash at a third pre-determined digit.

13. The system of claim 11, wherein the computer-executable instructions, when executed by the at least one processor, further cause the at least one processor to:
determine that the first value is different than the second value; and
identify, based on the determination that the first value is equivalent to the second value, a third value of the first hash that is different than the first value and the second value.

14. The system of claim 9, wherein the wherein the first value and the second value are used as values for at least one of a hue value, a saturation value, or a lightness value of a hue, saturation, and lightness (HSL) color scheme.

15. The system of claim 9, wherein generating the first hash is performed instead of using random number generation.

16. The system of claim 9, wherein the first hash of the first identifier is a hexadecimal hash.

17. A non-transitory computer-readable medium including computer-executable instructions stored thereon, which when executed by at least one processors, cause the at least one processors to:
encrypt a first identifier associated with a first object to generate a first hash of the first identifier;
select a first pre-determined digit of the first hash as a first variable in a color scheme;
select at least a second pre-determined digit of the first hash as a second variable in the color scheme;
determine a first value of the first hash at the first pre-determined digit;
determine a second value of the first hash at the second pre-determined digit;
generate a first color using the first value and the second value; and
present a user interface including the first object and the first color associated with the first object.

18. The non-transitory computer-readable medium of claim 17, wherein the first value and the second value are used as values for at least one of a red value, a green value, or a blue value of a red, green, and blue (RGB) color scheme.

19. The non-transitory computer-readable medium of claim 17, wherein the wherein the first value and the second value are used as values for at least one of a hue value, a saturation value, or a lightness value of a hue, saturation, and lightness (HSL) color scheme.

20. The non-transitory computer-readable medium of claim 17, wherein generating the first hash is performed instead of using random number generation.
